(19) United States
(12) Patent Application Publication
(10) Pub. No.: US 2025/0218107 A1
(43) Pub. Date: Jul. 3, 2025

(54) INFORMATION PROCESSING DEVICE, INFORMATION PROCESSING METHOD, AND RECORDING MEDIUM

(71) Applicants: SONY GROUP CORPORATION, Tokyo (JP); Sony Interactive Entertainment Inc., Tokyo (JP)

(72) Inventors: Sho OGURA, Tokyo (JP); Nami FURUHASHI, Tokyo (JP); Takashi IMAMURA, Tokyo (JP)

(73) Assignees: SONY GROUP CORPORATION, Tokyo (JP); Sony Interactive Entertainment Inc., Tokyo (JP)

(21) Appl. No.: 18/848,141

(22) PCT Filed: Mar. 24, 2023
(86) PCT No.: PCT/JP2023/011718

§ 371 Date: Sep. 18, 2024

(30) Foreign Application Priority Data
Mar. 30, 2022 (JP) 2022-056495

(51) Int. Cl. G06T 15/10; G06T 7/70; G06T 11/00; G06T 11/60; G06T 19/00

(52) U.S. Cl. CPC G06T 15/10; G06T 7/70; G06T 11/001; G06T 11/60; G06T 19/00; G06T 2200/04

(57) ABSTRACT

Provided is an information processing device including: a position information acquisition unit that acquires position information indicating a position of an exhibit in a virtual space; a comment registration unit that registers a comment on the exhibit in association with a specific position in the virtual space; a comment arrangement unit that disposes the comment in a vicinity of the exhibit on the basis of attribute information of the comment, position information indicating a position of an avatar present in the virtual space, and position information of the exhibit; and an image output unit that outputs an image of the virtual space from a specific viewpoint corresponding to the avatar on the basis of the comment that has been disposed. The present disclosure can be applied to, for example, a device that provides a virtual exhibition.

### FIELD

The present disclosure relates to an information processing device, an information processing method, and a recording medium, more particularly, to an information processing device, an information processing method, and a recording medium capable of more appropriately arranging comments on an exhibit in a virtual space.

### BACKGROUND

There is technology of arranging comments of users in a virtual space to vitalize communication among the users. For example, Patent Literature 1 discloses technology for making the time from arrangement of comments, arranged in a virtual space, to canceling of the arrangement longer as more support is received.

### CITATION LIST

### Patent Literature

Patent Literature 1: JP 2017-041780 A

### SUMMARY

### Technical Problem

In the conventional technology including the technology disclosed in Patent Literature 1, it is conceivable that comments cannot be appropriately arranged in a case of arranging the comments on an exhibit in a virtual space. Therefore, technology for more appropriately arranging comments on an exhibit in a virtual space is on demand.

The present disclosure has been made in view of such a situation and enables more appropriate arrangement of comments on an exhibit in a virtual space.

### Solution to Problem

An information processing apparatus in one aspect of the present disclosure includes; a position information acquisition unit that acquires position information indicating a position of an exhibit in a virtual space; a comment registration unit that registers a comment on the exhibit in association with a specific position in the virtual space; a comment arrangement unit that disposes the comment in a vicinity of the exhibit on the basis of attribute information of the comment, position information indicating a position of an avatar present in the virtual space, and position information of the exhibit; and an image output unit that outputs an image of the virtual space from a specific viewpoint corresponding to the avatar on the basis of the comment that has been disposed.

An information processing method and the recording medium in one aspect of the present disclosure are the information processing method and the recording medium corresponding to the information processing apparatus in one aspect of the present disclosure.

The information processing devise, information processing method and recording medium in one aspect of the present disclosure, perform the following processes; acquiring position information indicating a position of an exhibit in a virtual space; registering a comment on the exhibit in association with a specific position in the virtual space; disposing the comment in a vicinity of the exhibit on a basis of attribute information of the comment, position information indicating a position of an avatar present in the virtual space, and position information of the exhibit; and outputting an image of the virtual space from a specific viewpoint corresponding to the avatar on a basis of the comment that has been disposed.

The information processing apparatus according to one aspect of the present disclosure may be an independent apparatus or an internal block constituting a single apparatus.

### BRIEF DESCRIPTION OF DRAWINGS

FIG. 1 is a diagram illustrating a configuration example of an embodiment of a system to which the present disclosure is applied.

FIG. 2 is a block diagram illustrating a configuration example of a terminal device.

FIG. 3 is a block diagram illustrating a configuration example of a server.

FIG. 4 is a block diagram illustrating a functional configuration example of the server.

FIG. 5 is a diagram illustrating an example of comment states for an exhibit of a virtual exhibition.

FIG. 6 is a diagram illustrating an example of comment arrangement with respect to an exhibit.

FIG. 7 is a diagram illustrating a screen example of normal display.

FIG. 8 is a diagram illustrating a screen example of map display.

FIG. 9 is a diagram illustrating a screen example of a comment amount map.

FIG. 10 is a diagram illustrating a screen example of a comment amount heat map.

FIG. 11 is a flowchart explaining a flow of SNS sharing processing.

FIG. 12 is a diagram illustrating a screen example before comment display control is performed.

FIG. 13 is a diagram illustrating a screen example after the comment display control is performed.

FIG. 14 is a diagram illustrating an example of a control method of comment display for each user.

FIG. 15 is a diagram illustrating an example of comment display control depending on a background or an angle of view.

FIG. 16 is a flowchart illustrating a flow of comment display control processing.

FIG. 17 is a diagram illustrating an example of common information and personal information used for the comment display control.

FIG. 18 is a diagram illustrating an example of rearrangement of comments on an exhibit.

FIG. 19 is a diagram illustrating a configuration example for performing the comment display control depending on an importance level.

FIG. 20 is a diagram illustrating an example of 2D display of comments.

FIG. 21 is a diagram illustrating a first example of 3D display of comments.

FIG. 22 is a diagram illustrating a second example of 3D display of comments.

FIG. 23 is a diagram illustrating a configuration example for converting user's voice into 3D text.

FIG. 24 is a diagram illustrating examples of sharing of 3D text between a virtual space and a real space.

FIG. 25 is a diagram illustrating a configuration example for sharing 3D text between a virtual space and a real space.

FIG. 26 is a diagram illustrating a screen example including an artist's comment.

FIG. 27 is a flowchart explaining an overview of processing to which the present disclosure is applied.

### DESCRIPTION OF EMBODIMENTS

### <System Configuration>

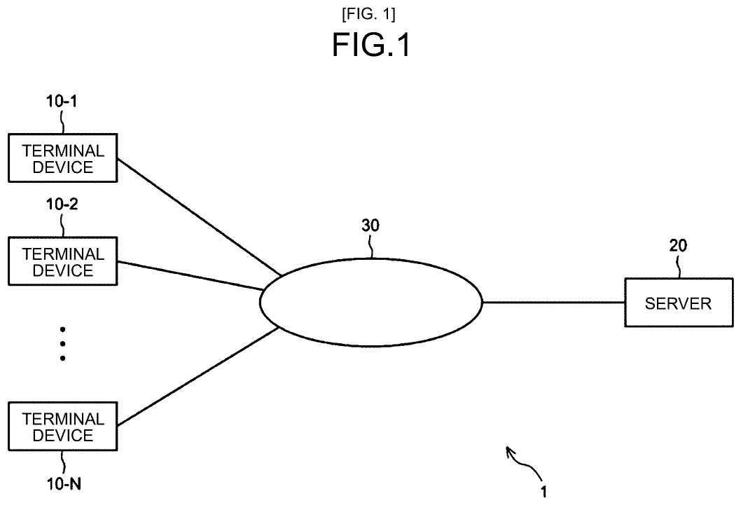

FIG. 1 is a diagram illustrating a configuration example of an embodiment of a system to which the present disclosure is applied. The system refers to a logical collection of a plurality of devices.

In FIG. 1, a system 1 includes terminal devices 10-1 to 10-N (N is an integer greater than or equal to 1) and a server 20. Each of the terminal devices 10-1 to 10-N and the server 20 are connected to each other via a network 30.

The terminal device 10-1 is, for example, an electronic device such as a smartphone, a personal computer (PC), a tablet terminal, a head mounted display (HMD), a game machine, or a music player. In the terminal device 10-1, an application (hereinafter, also referred to as an app) for providing a virtual space is installed, and for example, the user can participate in the virtual space using an avatar or the like that is a virtual self of the user. Note that the virtual space may be provided not only by the application but also by using a browser or the like.

The terminal devices 10-2 to 10-N are electronic devices such as smartphones or PCs similarly to the terminal device 10-1 and are used by different users, and each of the users can participate in the virtual space. In the following description, in a case where it is not necessary to distinguish the terminal devices 10-1 to 10-N, they are simply described as the terminal devices 10.

The server 20 has a function of providing the virtual space to the terminal devices 10-1 to 10-N. The server 20 transmits various types of data related to the virtual space to each of the terminal devices 10-1 to 10-N via the network 30. Each of the terminal devices 10-1 to 10-N receives various types of data transmitted from the server 20 via the network 30 and provides the virtual space to its user using the various types of data that has been received.

The server 20 records various types of data necessary for providing the virtual space. Furthermore, the server 20 manages various types of information such as user information regarding the users participating in the virtual space in a database and can use various types of information as necessary.

As the virtual space, for example, a virtual exhibition is provided. In the virtual exhibition, artists' artworks are exhibited as exhibits, and a user who participates using an avatar or the like can freely view the exhibited exhibits. In the following description, a case where the virtual exhibition is provided as the virtual space will be described as an example.

The network 30 includes a communication network such as the Internet, an intranet, or a mobile phone network and enables interconnection among devices using a communication protocol such as Transmission Control Protocol/Internet Protocol (TCP/IP).

Note that, although one server is illustrated in FIG. 1 for simplification of description, a plurality of servers may be included. Furthermore, another server such as an application server that provides the application or an SNS server that provides a social networking service (SNS) may be separately provided.

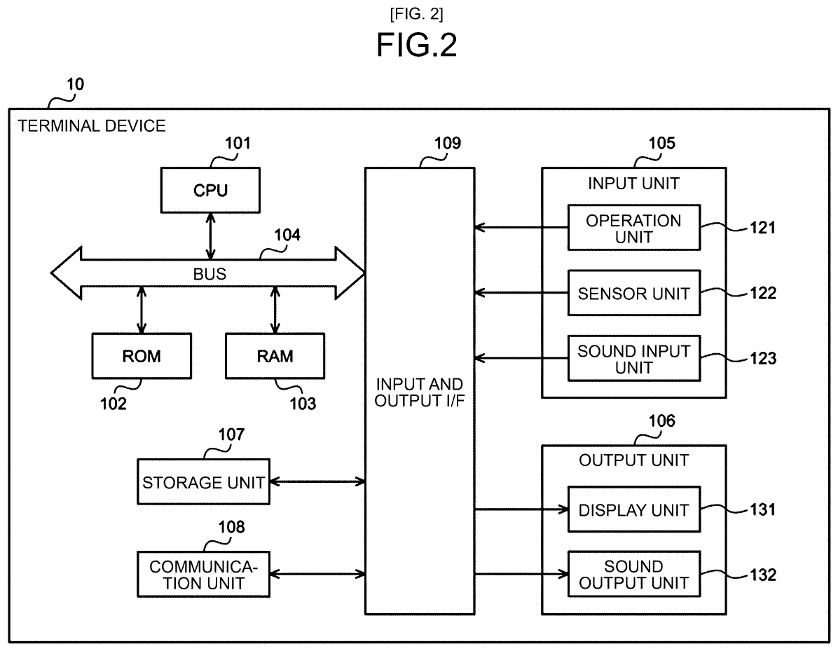

FIG. 2 is a block diagram illustrating a configuration example of a terminal device 10 in FIG. 1.

As illustrated in FIG. 2, in the terminal device 10, a central processing unit (CPU) 101, a read only memory (ROM) 102, and a random access memory (RAM) 103 are mutually connected by a bus 104.

The CPU 101 controls the operation of each unit of the terminal device 10 by executing a program recorded in the ROM 102 or a storage unit 107. Various types of data are stored in the RAM 103 as appropriate.

An input and output I/F 109 is also connected to the bus 104. An input unit 105, an output unit 106, the storage unit 107, and a communication unit 108 are connected to the input and output I/F 109.

The input unit 105 supplies various input signals to units including the CPU 101 via the input and output I/F 109. For example, the input unit 105 includes an operation unit 121, a sensor unit 122, and a sound input unit 123.

The operation unit 121 is operated by the user and supplies an operation signal corresponding to the operation to the CPU 101. The operation unit 121 includes physical buttons, a touch panel, a mouse, a keyboard, or the like.

The sensor unit 122 performs sensing of space information, time information, and others and outputs a sensor signal obtained as a result of the sensing. The sensor unit 122 includes an acceleration sensor, a gyro sensor, an inertial measurement unit (IMU), or others. The sensor unit 122 may include a camera including an image sensor.

The sound input unit 123 includes a microphone that collects sound such as user's voice and outputs a sound signal corresponding to the collected sound.

The output unit 106 outputs various types of information under the control by the CPU 101 via the input and output I/F 109. For example, the output unit 106 includes a display unit 131 and a sound output unit 132.

The display unit 131 includes a display and displays information such as an image, a video, or text corresponding to an image signal. The sound output unit 132 includes a speaker, a headphone connected to an output terminal, or others and outputs sound corresponding to a sound signal.

The storage unit 107 records various types of data and programs under the control by the CPU 101. The CPU 101 reads and processes various types of data from the storage unit 107 and executes a program. The storage unit 107 includes an auxiliary storage device such as a semiconductor memory. The storage unit 107 may be configured as an internal storage or may be an external storage such as a memory card.

The communication unit 108 communicates with other devices via the network 30 under the control by the CPU 101. The communication unit 108 includes a communication module compatible with cellular communication (for example, LTE-Advanced, 5G, or others), wireless communication such as a wireless local area network (LAN), or wired communication.

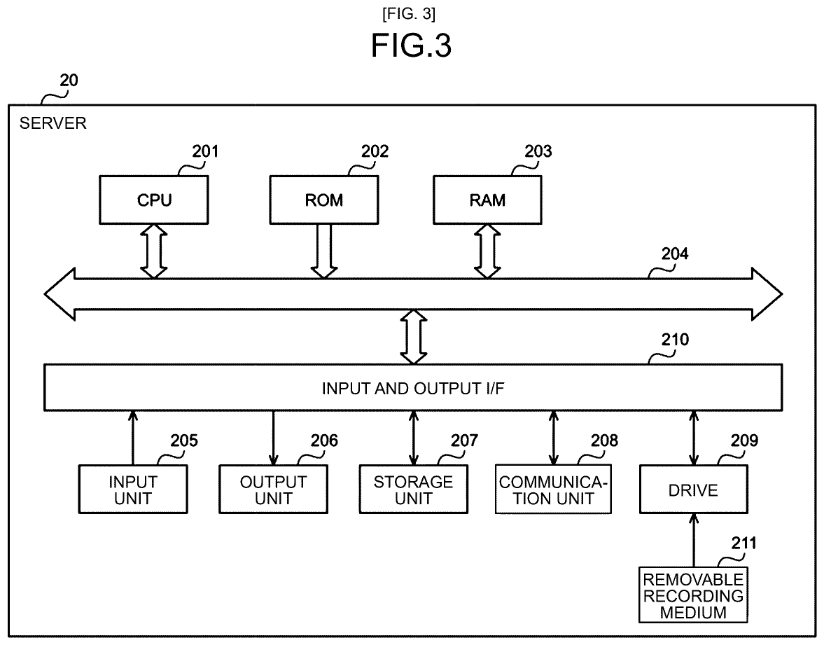

FIG. 3 is a block diagram illustrating a configuration example of the server 20 of FIG. 1.

As illustrated in FIG. 3, in the server 20, a CPU 201, a ROM 202, and a RAM 203 are mutually connected by a bus 204. An input and output I/F 210 is further connected to the bus 204. An input unit 205, an output unit 206, a storage unit 207, a communication unit 208, and a drive 209 are connected to the input and output I/F 210.

The input unit 205 includes a keyboard, a mouse, or others. The output unit 206 includes a speaker, a display, or others. The storage unit 207 includes an auxiliary storage device such as a hard disk drive (HDD) or a semiconductor memory.

The communication unit 208 includes a communication I/F compatible with wireless communication such as a wireless LAN or wired communication such as Ethernet (registered trademark). The drive 209 drives a removable recording medium 211 such as a semiconductor memory, an optical disk, a magnetic disk, or a magneto-optical disk.

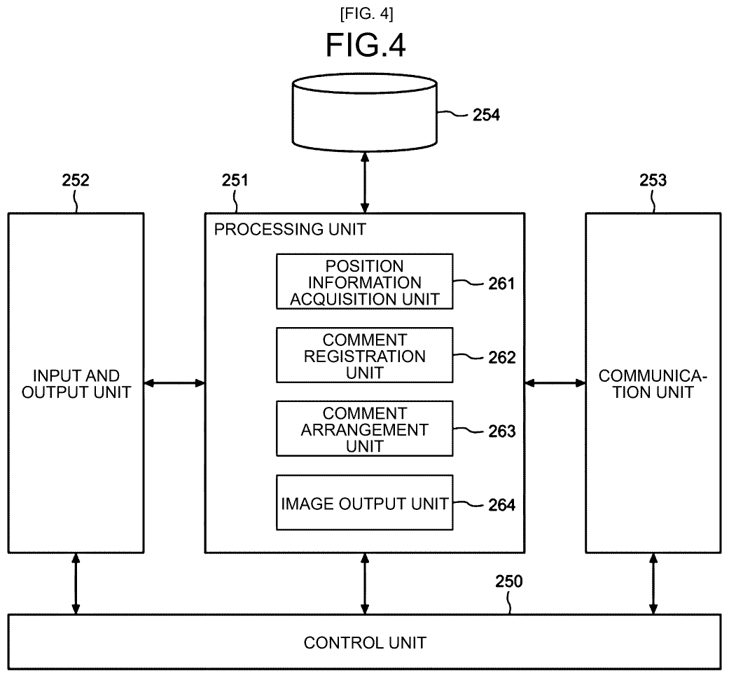

FIG. 4 is a block diagram illustrating a functional configuration example of the server 20 of FIG. 3.

In FIG. 4, a control unit 250 corresponds to the CPU 201 in FIG. 3, an input and output unit 252 corresponds to the input unit 205 and the output unit 206 in FIG. 3, a communication unit 253 corresponds to the communication unit 208 in FIG. 3, and a storage unit 254 corresponds to the storage unit 207 in FIG. 3. The function of a processing unit 251 is implemented with the CPU 201 in FIG. 3 executing a program. Alternatively, all or some of the functions of the processing unit 251 may be implemented by dedicated hardware.

The processing unit 251 performs processing for providing a virtual space such as a virtual exhibition. The storage unit 254 records various types of data and various types of information necessary for providing a virtual space such as a virtual exhibition. The processing unit 251 records various types of data or various types of information in the storage unit 254 and reads various types of data or various types of information recorded in the storage unit 254.

The processing unit 251 includes a position information acquisition unit 261, a comment registration unit 262, a comment arrangement unit 263, and an image output unit 264.

The position information acquisition unit 261 acquires position information in the virtual space. The position information includes position information indicating the position of an exhibit in the virtual space, position information indicating the position of a comment on the exhibit in the virtual space, and position information indicating the position of an avatar present in the virtual space.

The comment registration unit 262 registers the comment on the exhibit in the virtual space in association with a specific position in the virtual space. Data related to comments is recorded in the storage unit 254.

The comment arrangement unit 263 arranges comments in the vicinity of the exhibit in the virtual space on the basis of the position information acquired by the position information acquisition unit 261 and data recorded in the storage unit 254.

The image output unit 264 outputs an image of the virtual space from a specific viewpoint corresponding to the avatar on the basis of the comments arranged by the comment arrangement unit 263. The output image of the virtual space is displayed on the display unit 131 of the terminal device 10.

Note that, although the functional configuration example of the server 20 has been illustrated in FIG. 4, all or some pieces of processing of the processing executed by the processing unit 251 may be executed by a terminal device 10. That is, the function of the processing unit 251 is not limited to implementation on the server 20 side but may be implemented on the terminal device 10 side with the CPU 101 in FIG. 2 executing a program, for example. Therefore, in the following, description of processing executed by the processing unit 251 means the processing unit 251 of the server 20 or a processing unit 251 of a terminal device 10. The server 20 and the terminal devices 10 are examples of an information processing device to which the present disclosure is applied.

### <Comment State>

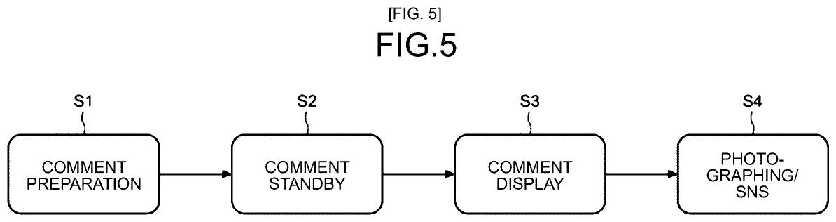

FIG. 5 is a diagram illustrating an example of comment states for an exhibit in the virtual space which is the virtual exhibition.

The comment states are roughly classified into four states of comment preparation (S1), comment standby (S2), comment display (S3), and photographing/SNS (S4). The comment preparation and the comment display are basically performed by different users.

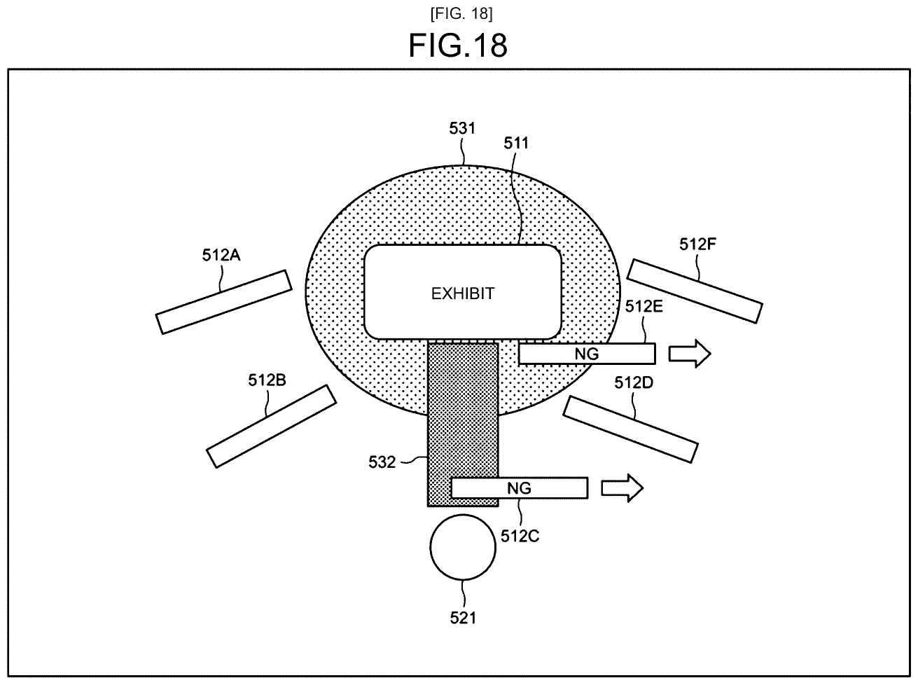

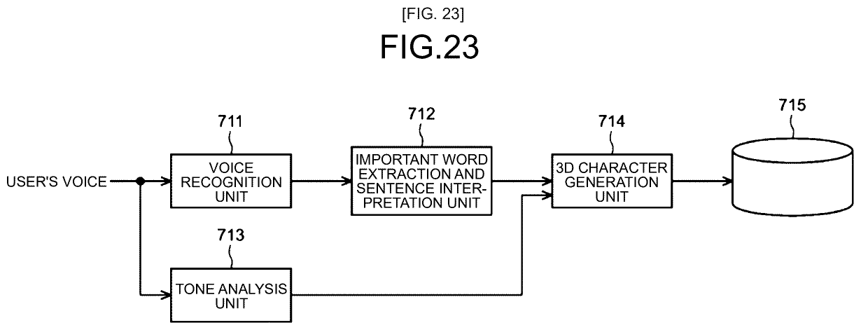

In the comment preparation (S1) state, a user who prepares the comment on the exhibit in the virtual space writes the comment or arranges the comment, whereby the comment on the exhibit is registered in association with a specific position in the virtual space. In the following description, rearrangement of comments (FIG. 18) and conversion of user's voice into 3D text (FIGS. 23 to 25) will be described as an example of comment preparation.

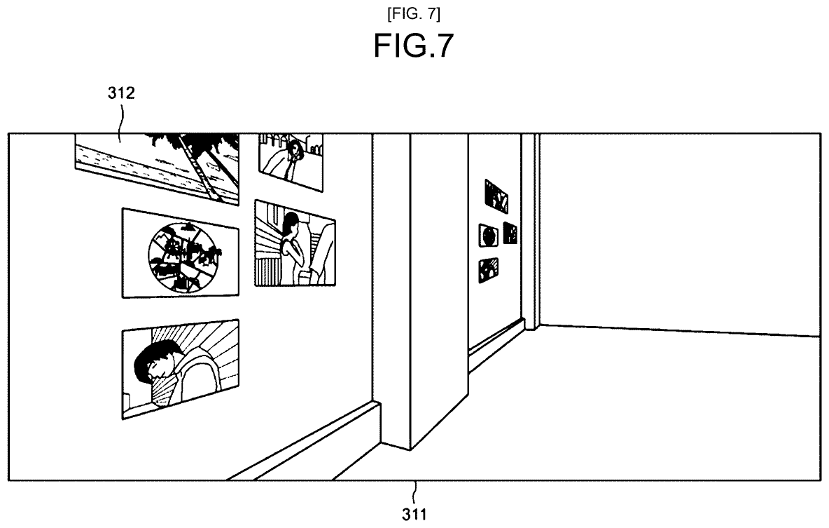

The state of the comment standby (S2) is a state of a comment from preparation to display. Although there is a case where all the comments registered at specific positions in the virtual space are always displayed depending on the position of the user in the virtual space, it is also possible to switch between displaying and hiding depending on the distance to the user or the like. In the following description, map display of the comment amount (FIGS. 7 to 10) will be described as an example of comment standby.

In the state of the comment display (S3), the comments registered at the specific positions in the virtual space are displayed to the user moving in the virtual space (the user different from users who have created the comments). The user can view the displayed comments and take a reaction to a comment such as evaluating as “like”.

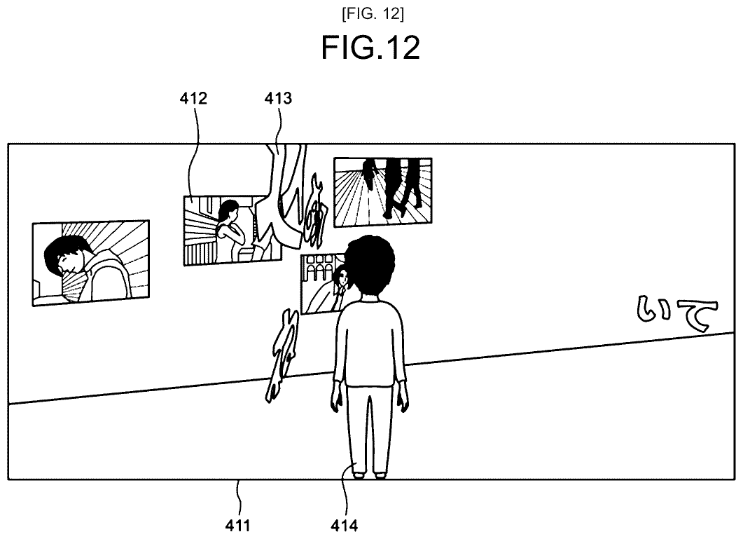

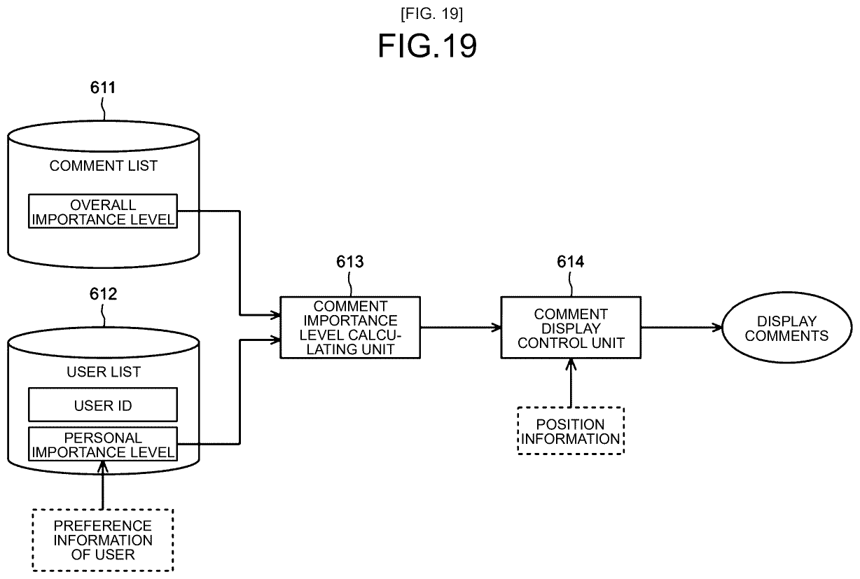

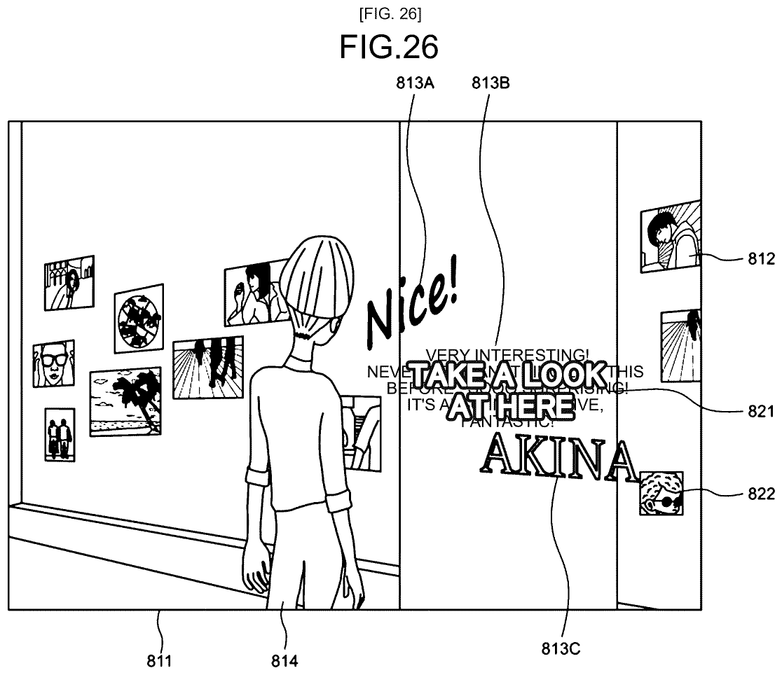

The comments may be displayed commonly to all users or may be displayed differently for each user. Furthermore, it is also possible to perform display control such as moving a comment or deleting a comment at predetermined timing. In the following description, as an example of the comment display, comment display for each user (FIGS. 12 to 17), how to show comments (FIGS. 19 to 22), and communication with an artist (FIG. 26) will be described.

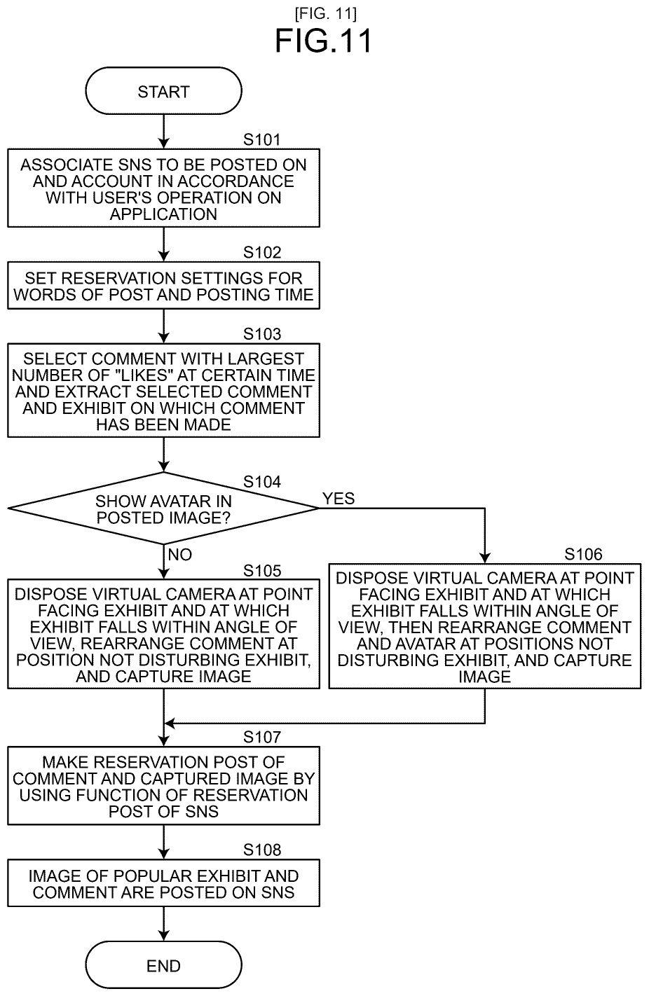

In the photographing/SNS (S4), comments registered in the virtual space and an exhibit corresponding to the comments are photographed (captured) and posted on external SNS. In the following description, SNS sharing (FIG. 11) will be described as an example of photographing/SNS.

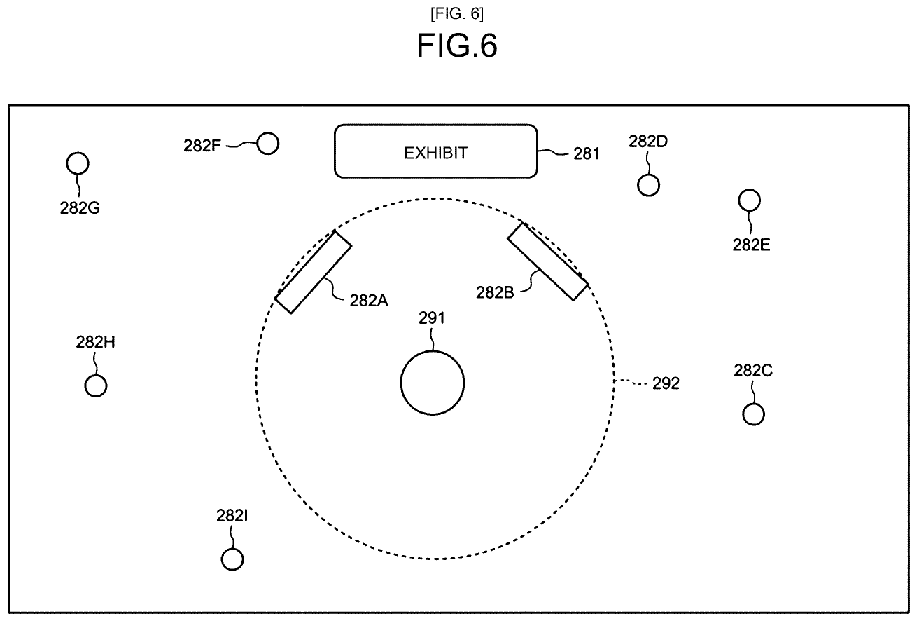

In this example, the comments on the exhibit in the virtual space can be displayed to the user as in the top view illustrated in FIG. 6, for example. In FIG. 6, comments 282A to 282I are registered for an exhibit 281. At this point, when the viewpoint position of the user is at a position 291, an area 292 indicated by a dashed circle centered on the position 291 can be set as an area where comments can be displayed.

Therefore, the comments 282A and 282B in the area 292 are displayed as they have been registered (normal display). Meanwhile, the comments 282C to 282I outside the area 292 can be displayed differently from the normal display by displaying registered comments with a reduced information amount such as simple display instead of displaying the registered comments as they are. Note that the position 291 corresponds to the viewpoint position of the user who is using the terminal device 10 in which the application has been activated and can be set to a specific viewpoint corresponding to an avatar in a case where the avatar acting in the virtual space is operated, for example.

### <Map Display of Comment Amount>

When the user views the exhibit in the virtual space, the amount of comments on the exhibit is superimposed and displayed on a map of the virtual exhibition, whereby the user can recognize the highlight of the virtual exhibition.

For example, when the user operates the terminal device 10 on which the application has been activated and views the exhibit in the virtual space, a terminal screen 311 of normal display as illustrated in FIG. 7 is displayed on the display unit 131. Since exhibits 312 such as a picture or a photograph installed in the virtual space are displayed on the terminal screen 311, the user can move in the virtual space or change the viewpoint by operating the operation unit 121, whereby the user can see an exhibit that the user is interested in.

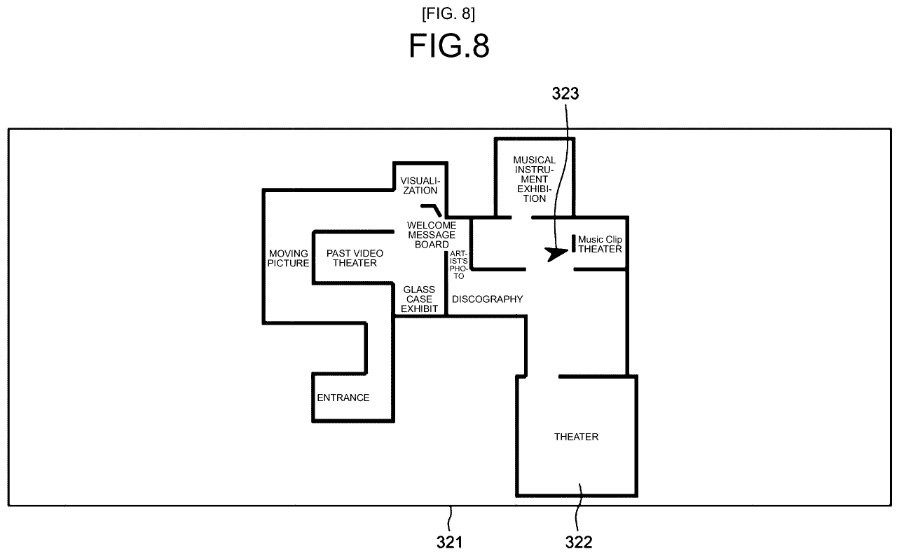

In addition, when the user performs a predetermined operation by operating the operation unit 121 or the like, a terminal screen 321 of map display as illustrated in FIG. 8 is displayed on the display unit 131. On the terminal screen 321, a map 322 of the virtual exhibition is displayed, and an icon 323 indicating the current position of the user is displayed in a superimposed manner. The user can check the current position of the user in the venue of the virtual exhibition by the icon 323. In addition, the user can randomly access to other areas by selecting a desired exhibition area (exhibit) by operating the operation unit 121 while checking the current position of the user. That is, the map 322 is a bird's-eye view image of the venue of the virtual exhibition and is mapped with exhibition areas (exhibits) in the virtual space.

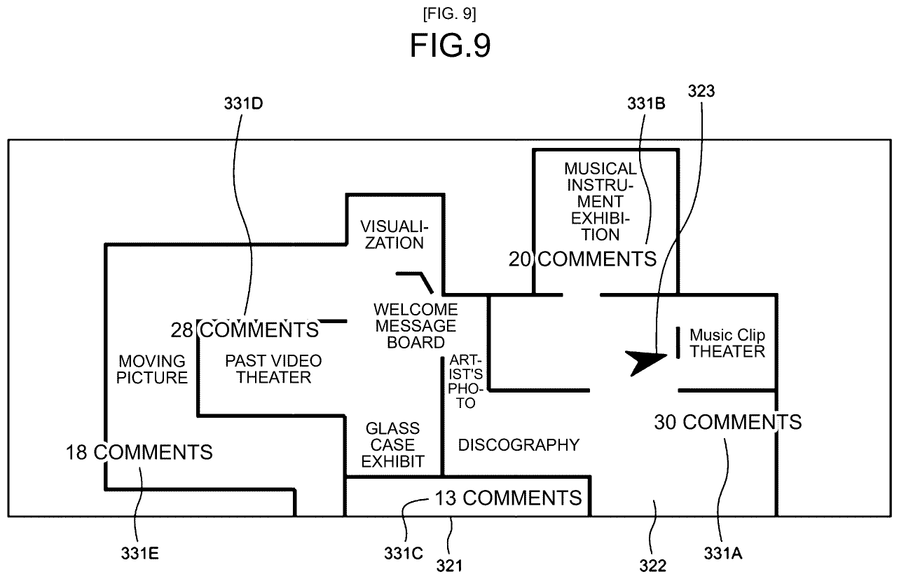

At this point, the amounts of comments (comment amount) on the exhibits can be superimposed and displayed on the map 322. In the terminal screen 321 of the map display of FIG. 9, the upper area of the map 322 of FIG. 8 is enlarged and displayed, and comment amounts 331A to 331E for the exhibits are superimposed and displayed on the enlarged map 322. In the virtual exhibition, there are exhibition areas such as a music clip theater, a musical instrument exhibition, a discography, a past video theater, and a moving picture, and these exhibition areas are displayed as the map 322 on the terminal screen 321 in FIG. 9.

On the terminal screen 321 in FIG. 9, the comment amount 331A of “30” is superimposed on the music clip theater on the map 322, the comment amount 331B of “20” is superimposed on the musical instrument exhibition, and the comment amount 331C of “13” is superimposed on the discography. Moreover, the comment amount 331D of “28” is superimposed on the past video theater, and the comment amount 331E of “18” is superimposed on the moving picture. In this example, the numerical value of the comment amount represents the number of comments on an exhibit in a predetermined period (a period such as a month or a day).

In this manner, since the comment amount is displayed on the map 322, for example, the user can recognize that the comment amount for the music clip theater or the past video theater is large to recognize that these exhibition areas are attracting more attention. Note that the map 322 in FIGS. 8 and 9 may be superimposed and displayed on the terminal screen 311 of the normal display in FIG. 7.

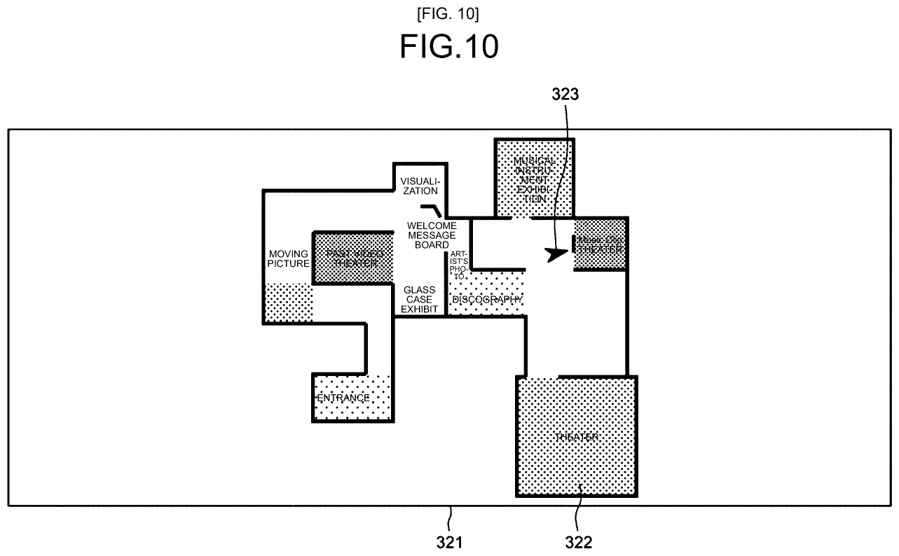

On the terminal screen 321 of the map display of FIG. 9, the comment amounts for the exhibits installed in the exhibition area on the map 322 are represented by a numerical value corresponding to the number of comments; however, the comment amount is not limited to the numerical value and may be represented by another method. For example, as illustrated in FIG. 10, the comment amounts for the exhibits may be visualized by a heat map in which the comment amounts are expressed by colors or tones.

On the terminal screen 321 of the map display in FIG. 10, the comment amounts on the exhibits are expressed by the dot density. For example, the music clip theater and the past video theater, which are exhibition areas with a high dot density, are expressed in red or the like since the comment amount is large, and the musical instrument exhibition, the moving picture, and a theater, which are exhibition areas with a next high dot density, are expressed in orange or the like since the comment amount is slightly large. In addition, the discography and the entrance are expressed in yellow or the like since the comment amount is small, and the other exhibition areas are expressed in green or the like since there are almost no comments.

In this manner, by visualizing the excitement of the exhibition areas by adding colors and tones corresponding to the comment amount on the map 322, the user can intuitively recognize the places attracting more attention in the virtual exhibition.

An exhibition tour may be automatically generated on the basis of the comment amounts on the exhibits. For example, the exhibition tour can be automatically generated by extracting exhibits with a comment amount greater than or equal to 20 and determining a route of short distances on the basis of distances between the extracted exhibits. More specifically, an exhibition tour of viewing exhibits of the past video theater, exhibits of the musical instrument exhibition, and exhibits of the music clip theater in the order mentioned along the route is automatically generated and can be presented to the user.

For example, at the time of presenting the exhibition tour, the exhibits are automatically switched and displayed at predetermined timing in the order of the route of the past video theater, the musical instrument exhibition, and the music clip theater on the display unit 131 of the terminal device 10 in which the application has been activated, and thus the user can enjoy the exhibition tour without manual operation. Note that the user may move between exhibits in the virtual space by manual operation depending on the content of the exhibition tour.

Note that, in the example described above, the total number of comments for each exhibit under predetermined conditions has been presented as the comment amount; however, a value regarding the comment amount may be calculated by another index. The comment amount may be displayed for each exhibition area in which a plurality of exhibits is installed as well as for each exhibit.

As described above, the map display of the comment amounts corresponds to the comment standby (S2) among the comment states of FIG. 5, and the comment amounts pf the exhibits are superimposed and displayed on the map of the virtual exhibition, which makes it possible to allow the user to recognize the exhibition areas with a large comment amount as places attracting more attention.

For example, by viewing the comment amounts superimposed on the map 322 of the terminal screen 321 in FIG. 9 or 10, the user can intuitively recognize exhibits to particularly view among the plurality of exhibits on display. Furthermore, when the user, who has checked the terminal screen 321 in FIG. 9 or 10, moves to an exhibition area attracting more attention with a large comment amount, the display unit 131 displays the exhibits comments on the exhibits together with the exhibits, and thus the user can see the comments.

### <SNS Sharing>

Capturing a comment registered in the virtual space and an exhibit corresponding to the comment and posting them on external SNS makes it possible to share the posted image with other users.

A flow of SNS sharing processing will be described with reference to a flowchart of FIG. 11. The SNS sharing processing is executed by the processing unit 251 of a terminal device 10 or the server 20.

In step S101, the processing unit 251 associates the SNS to which the comment is to be posted with the account of the user in accordance with a user's operation on the application. In step S102, the processing unit 251 sets reservation settings for words of a post and posting time in accordance with a user's operation. The application in this example is not limited to the application for providing the virtual space, and other applications may be used.

In step S103, the processing unit 251 selects a comment with the largest number of “likes” at a certain time and extracts the selected comment and the exhibit on which the comment has been made. For example, when selecting a comment, a period such as a month or a day can be set, and the comment can be selected on the basis of the total amount of “likes” in the set period.

In step S104, it is determined whether or not to show the avatar in the posted image to be posted on the SNS. If the avatar is not shown in the posted image (No in S104), the processing proceeds to step S105. In step S105, the processing unit 251 disposes, in the virtual space, a virtual camera at a point facing the exhibit and at which the exhibit falls within the angle of view, rearranges the comment at a position not disturbing the exhibit, and captures an image. As a result, an image including the exhibit and the comment from the viewpoint of the virtual camera is captured.

On the other hand, if the avatar is shown in the posted image (Yes in S104), the processing proceeds to step S106. However, as a premise for the avatar to be shown in the posted image, an avatar that the user wants to show is to be selected in advance in accordance with a user's operation in initial settings (such as S101 and S102), and the avatar is made to view the exhibit. In step S106, the processing unit 251 disposes, in the virtual space, the virtual camera at a point facing the exhibit and at which the exhibit falls within the angle of view, then rearranges the comment and the avatar at positions not disturbing the exhibit, and captures an image. As a result, an image including the exhibit, the comment, and the avatar from the viewpoint of the virtual camera is captured.

When the processing of step S105 or S106 ends, the processing proceeds to step S107. In step S107, the processing unit 251 makes a reservation post of the comment (words of the post in the reservation settings) and the captured image (the image captured in S105 or S106) by using a function of reservation post of the SNS. Then, when the posting time in the reservation settings is reached, the comment (words of the post in the reservation settings) and the captured image are posted on the SNS (S108).

The image posted in this example is an image including a comment with the largest total number of “likes” and the exhibit that is commented, which is an image of a popular exhibit. That is, the image of the popular exhibit corresponds to the set period and is regarded as, for example, an image of a popular exhibit of the month or an image of a popular exhibit of the day.

Note that there may be a case where photographing is prohibited depending on an exhibit or an exhibition area, and, optionally, it is also possible to exclude comments on exhibits or exhibition areas, photographing of which is prohibited, from comment candidates to be included in an image to be posted in advance. Furthermore, in the example described above, the comment having the largest number of “likes” at a certain time is selected; however, the selection method of a comment is not limited thereto, and other selection methods may be adopted as long as a specific comment can be selected.

As described above, the SNS sharing corresponds to the photographing/SNS (S4) among the comment states of FIG. 5, and an image including a comment having many favorable evaluations as users' reactions within a certain period of time and an exhibit that is commented is posted on an external SNS. As a result, the excitement of the comments is shared with the external SNS, which makes it possible to share it not only with users using the application but also with other users using the SNS.

### <Comment Display for Each User>

In a case where there are an exhibit and comments on the exhibit in the virtual space, depending on the arrangement of the comments, there is a possibility that a comment overlaps with the exhibit, and it becomes difficult for the user to see the exhibit. Furthermore, there may be a problem that it is difficult for the user to read the comments depending on the orientation of the arranged comments. Therefore, by performing display control of adjusting the position, the orientation, and the like of the comments on the basis of information such as the position of each user and the position of the exhibit, the comments on the exhibit are appropriately arranged in the virtual space.

For example, let us assume a case where a terminal screen 411 as illustrated in FIG. 12 is displayed with the user moving in the virtual space by operating the terminal device 10 on which the application has been activated. On the terminal screen 411, an exhibit 412 is displayed on a wall in the virtual space; however, since a comment 413 is disposed to cover a part of the exhibit 412 in the three-dimensional space, the user cannot see the part of the exhibit 412. Furthermore, since the orientation of the comment 413 is not facing the user, the user cannot read the content of the comment 413.

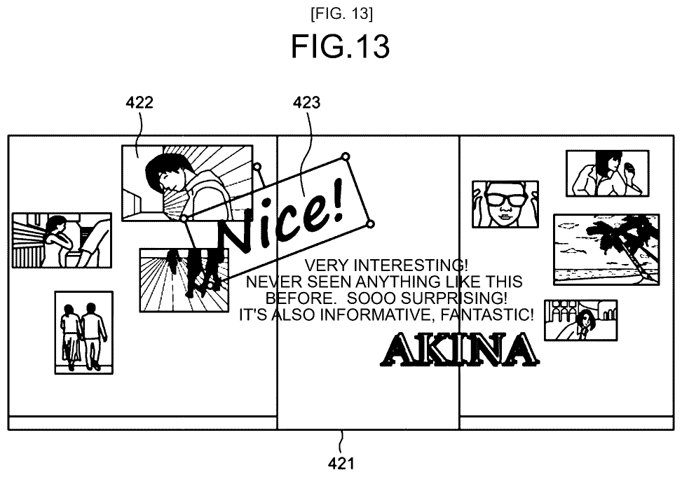

On the other hand, it is possible to display a terminal screen 421 as illustrated in FIG. 13 by performing display control of adjusting the position and the orientation of comments. On the terminal screen 421, control is performed to adjust the position, the orientation, the color, the size, and the like of the comments on the basis of information such as the position of each user and the position of the exhibit, whereby a comment 423 on an exhibit 422 is appropriately disposed.

That is, on the terminal screen 421, even when the comment 423 covers a part of the exhibit 422, the color of the comment 423 is adjusted depending on the background and the character size of the comment 423 is adjusted depending on the angle of view. Therefore, the user can view the exhibit 422 without being disturbed by the comment 423 and can check the content of the comment 423.

Note that, on the terminal screen 411 in FIG. 12, an avatar 414 of the user who operates the terminal device 10 is displayed in the virtual space and performs an action corresponding to the user's operation. Whether to display the avatar on the terminal screen is optional, and a terminal screen corresponding to the viewpoint of the user may be displayed without displaying the avatar as in the terminal screen 421 in FIG. 13.

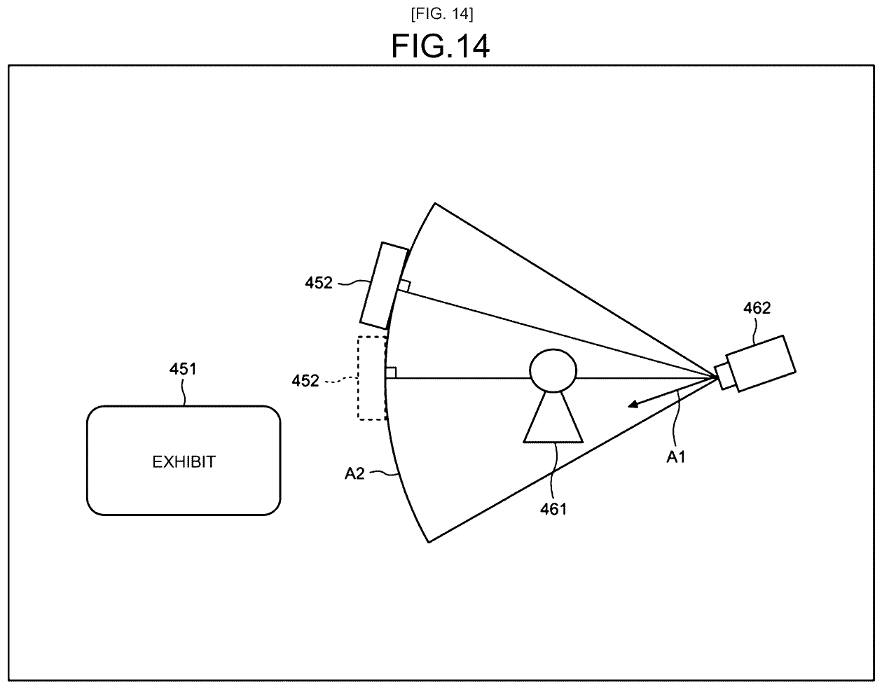

FIG. 14 is a diagram illustrating an example of display control of comments for each user. In FIG. 14, in a case where a comment 452 is disposed for an exhibit 451, display control is performed to move the comment 452 from a position indicated by a broken line to a position indicated by a solid line.

Specifically, in FIG. 14, an arrow A1 from a virtual camera 462 in the virtual space indicates the direction of a viewpoint vector corresponding to the viewpoint of the user, and an avatar 461 is disposed in this direction. At this point, in a case where the comment 452 is disposed at the position of the broken line, there is a possibility that the comment 452 overlaps with the exhibit 451 from the viewpoint of the user. Therefore, in FIG. 14, assuming an arc A2 centered on the virtual camera 462, control is performed such that the comment 452 faces the center by moving the comment 452 on the arc A2 to change the angle.

In this display control, for example, the following parameters are used when controlling the position and the orientation of the comment 452 with respect to the exhibit 451. That is, the current position of the avatar 461, field-of-view information regarding the viewpoint of the user who uses the terminal device 10 (the orientation of the virtual camera 462), position information (coordinates) of the exhibit 451 and the comment 452 in the virtual space, and others. Furthermore, the importance level of the comment 452, a preset important area (such as an area set for the exhibit 451) that the comment 452 should not overlap, and others can be included in the parameters.

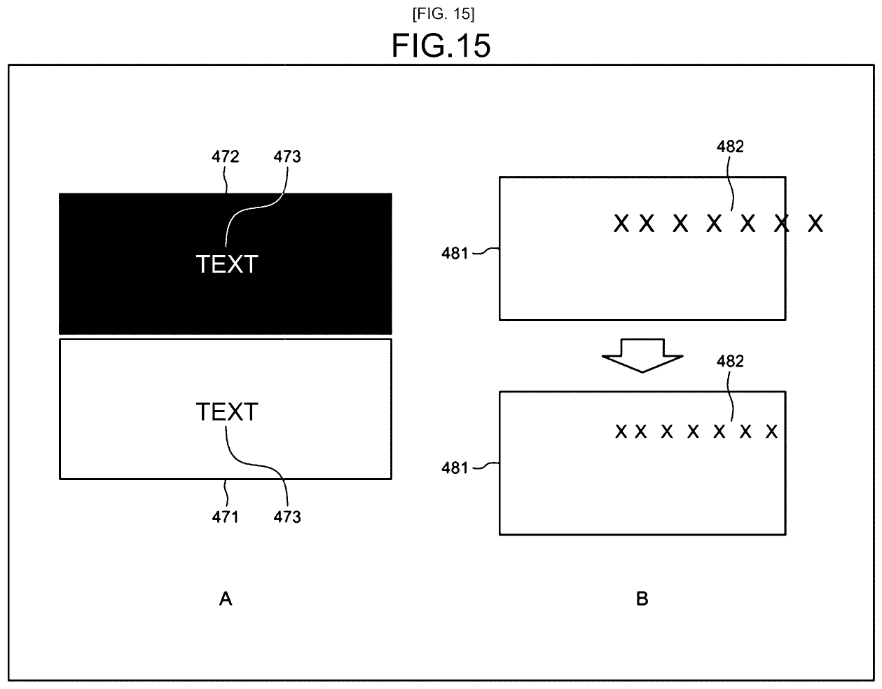

Furthermore, illustrated in FIG. 14 is the display control regarding the position and the orientation of the comment 452; however, in a case where the display control depending on the background or the angle of view is performed, comment display control as illustrated in FIG. 15, for example, is performed.

In A of FIG. 15, illustrated is an example of color adjustment control of a comment depending on the background. In A of FIG. 15, the color of a comment 473 is changed depending on a background 471 and a background 472. In B of FIG. 15, illustrated is an example of adjustment control of the character size or the interline spacing of a comment depending on the angle of view. In B of FIG. 15, control is performed such that a comment 482 falls within an angle of view 481 by adjusting the character size or the interline spacing of the comment 482 depending on the angle of view 481. In this adjustment control, it suffices to adjust at least one of the character size or the interline spacing of the comment.

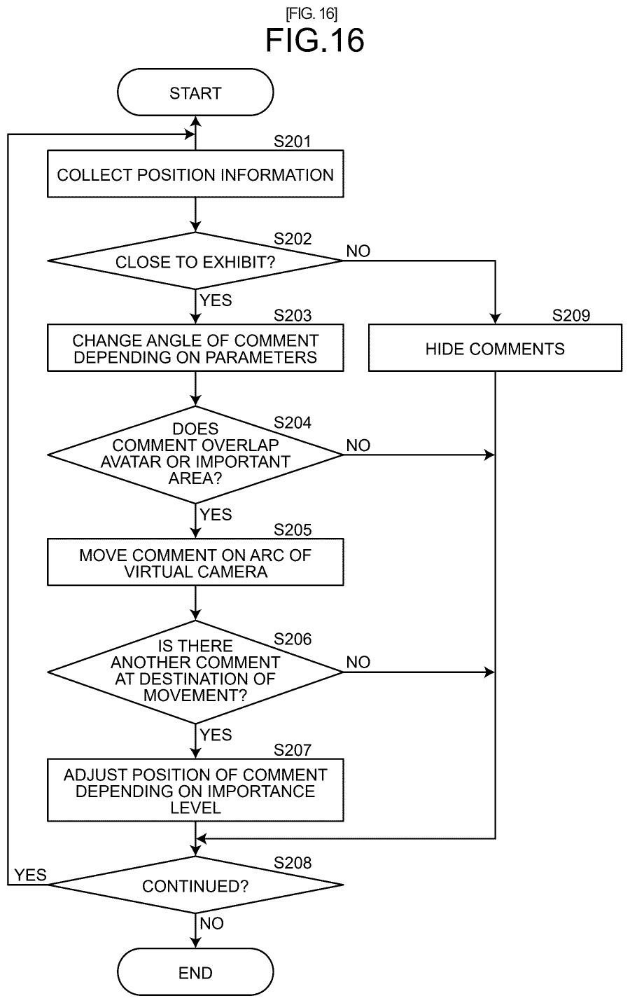

Next, a flow of comment display control processing depending on the movement of the user (avatar) in the virtual space will be described with reference to the flowchart in FIG. 16. The comment display control processing is executed by the processing unit 251 of a terminal device 10 or the server 20.

In step S201, the processing unit 251 acquires and collects position information depending on the movement of the user (avatar) in the virtual space. In this example, in a case where the user operates the avatar, for example, position information indicating the current position of the avatar and position information of an exhibit that the avatar is approaching are acquired.

In step S202, the processing unit 251 determines whether or not the user (avatar) is close to an exhibit on the basis of the acquired position information. If it is determined that the user is close to an exhibit (Yes in S202), the processing proceeds to step S203. In step S203, the processing unit 251 changes the angle of a comment with respect to the target exhibit depending on the parameters such as the position information and the field-of-view information of the avatar.

In step S204, the processing unit 251 determines whether or not the comment on the target exhibit overlaps the avatar or the important area (for example, an area set to the exhibit). If it is determined that the comment overlaps the avatar or the important area (Yes in S204), the processing proceeds to step S205. In step S205, the processing unit 251 moves the comment on the arc of the virtual camera. This movement control is similar to the control illustrated in FIG. 14.

In step S206, the processing unit 251 determines whether or not there is another comment at the destination of the comment moved on the arc. If it is determined that there is already another comment at the destination (Yes in S206), the processing proceeds to step S207.

In step S207, the processing unit 251 adjusts the position of the comment depending on the importance level of the comment. For example, it is possible to compare the importance level of the comment moved on the arc with the importance level of another comment originally present at the destination and to dispose the comment, having a lower importance level, away in the depth direction or away towards an end side, or the like in the virtual space. As a result, among the plurality of comments, comments arranged at overlapping positions can be moved to non-overlapping positions. When the processing of step S207 ends, the processing proceeds to step S208.

Meanwhile, if it is determined in step S202 that the user (avatar) is far from any exhibit (No in S202), the processing proceeds to step S209. In step S209, the processing unit 251 hides the comments on the exhibits. When the processing of step S209 ends, the processing proceeds to step S208.

Moreover, if it is determined in step S204 that the comment does not overlap the avatar or the important area (No in S204), or if it is determined in step S206 that there is no other comment at the destination (No in S206), the processing proceeds to step S208.

In step S208, the processing unit 251 determines whether or not the movement of the user (avatar) continues. If it is determined that the movement of the user continues (Yes in S208), the processing returns to step S201, and the above-described processing is repeated. On the other hand, if it is determined that the movement of the user is not continued (No in S208), the series of processing ends.

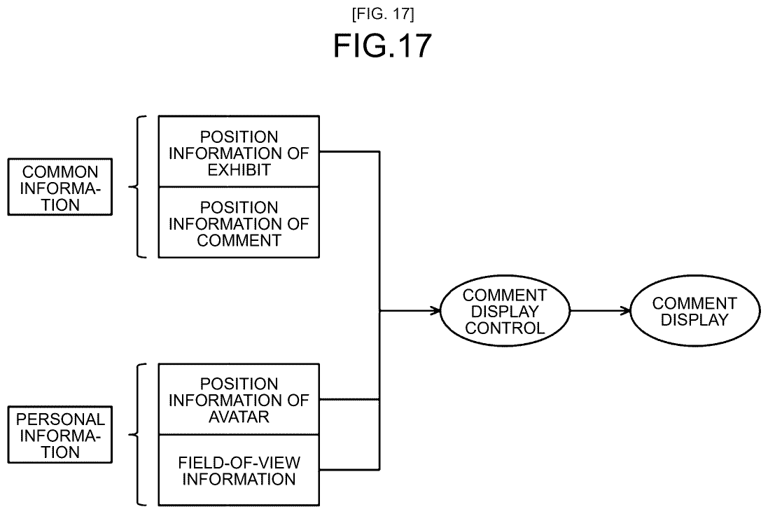

Incidentally, the parameters used in the series of processing described above include, for example, common information common to all users and personal information for each user as illustrated in FIG. 17. The common information includes at least the position information of the exhibits and the position information of the comments. The personal information includes at least the position information of the avatar and the field-of-view information of the user. In the series of processing described above, the comment display control using these parameters is performed, whereby the comments on the exhibits in the virtual space are appropriately arranged and displayed.

Although not illustrated in FIG. 17, the importance level of the comments, the important areas that a comment should not overlap, and the like are also included in the parameters used in the series of processing. The importance level of the comments and the important areas can be set in advance. Note that, in the series of processing described above, such control may be performed that all comments on an exhibit are deleted when the user (avatar) approaches the exhibit with less a predetermined distance thereto in the virtual space.

As described above, the comment display for each user corresponds to the comment display (S3) among the comment states of FIG. 5, and the comments can be more appropriately arranged by adjusting the orientation, the position, the color, the size, or others of the comments as appropriate with respect to the exhibits in the virtual space for each user using various parameters. The various parameters include attribute information of the comments, the position information of the avatar, the position information of the exhibits, and others. In addition, in the adjustment control, it is not necessary to adjust all of the orientation, the position, the color, and the size of the comments, and it suffices to adjust at least one of them. As a result, the user can reliably view the comments on the exhibits.

### <Rearrangement of Comments>

By setting a comment-free area as a place where no comments can be placed, it becomes possible to rearrange comments such that no comments are arranged in the comment-free area. As timing for determining the comment-free area, there are a method of determining a place where no comments can be placed in advance and a method of determining a place where no comments can be placed from the movement of the user.

That is, in the former method, when a comment is disposed at a position closer than the important area set in the exhibit or the like at the time of registering the comment, the comment is automatically moved to the outside of the important area. As a result, no comments can be placed in a place where comments cannot be placed, such as an important area determined in advance.

In the latter method, viewing direction information regarding the viewing direction in which many users view an exhibit is collected, and in a case where a comment is disposed on an area (hereinafter, referred to as a typical viewing direction area) depending on the viewing direction information, the comment is automatically moved to a position where the comment does not disturb. It can also be said that the viewing direction information relates to a specific viewpoint corresponding to the avatar present in the virtual space. As a result, no comments are arranged in the typical viewing direction area.

FIG. 18 is a diagram illustrating an example of rearrangement of comments on an exhibit in the virtual space. In FIG. 18, in a case where comments 512A to 512F are arranged with respect to an exhibit 511, an important area 531 as a comment-free area is set in advance. At this point, among the comments 512A to 512F, since the comment 512E is disposed in the important area 531, the comment 512E is moved to the outside of the important area 531 as indicated by a rightward arrow in the drawing.

Furthermore, a typical viewing direction area 532 as a comment-free area is set in a direction from a position 521 corresponding to a viewpoint position of the user towards the exhibit 511. At this point, among the comments 512A to 512F, since the comment 512C is disposed in the typical viewing direction area 532, the comment 512C is moved to the outside of the typical viewing direction area 532 as indicated by a rightward arrow in the drawing.

As described above, the rearrangement of the comments corresponds to the comment preparation (S1) among the comment states of FIG. 5, and in a case where a comment is disposed in a comment-free area statically or dynamically set, the comment can be rearranged and moved to the outside of the comment-free area. As a result, it is possible to arrange the comments more appropriately. Note that the processing of rearranging the comments is executed by the processing unit 251 (comment arrangement unit 263).

### <How to Show Comments>

If all the comments are treated equally when the comments on the exhibits are arranged in the virtual space, it is likely to become difficult to distinguish a comment that the user wants to see. Therefore, the comments on the exhibits are made to be appropriately displayed in the virtual space by performing display control (control of noticeability of the comments) such that the manner how to show the comments is modified depending on the importance level of the comments, reactions of users to the comments, and others.

FIG. 19 is a diagram illustrating a configuration example for performing the comment display control depending on an importance level. As illustrated in FIG. 19, in a comment list 611 storing a list of comments on exhibits, an overall importance level is stored for each comment. An overall importance level is a collective importance. For example, the overall importance level becomes higher as a comment receives more evaluations of “like” by a large number of users.

Furthermore, in a user list 612 storing a list of users who use the app, a personal importance level is stored in association with a user ID for identifying each user. A personal importance level is an importance level customized to an individual user and can be determined by, for example, preference information of the user. For example, in a case where the user is a fan of a specific artist, the importance level of the artist becomes high. The personal importance level may be manually set by the user or may be automatically set from an analysis result of the user's behavior in the virtual space (for example, looking at a specific exhibit for a long time).

A comment importance calculating unit 613 calculates the importance level of a comment to be arranged on the basis of the overall importance level stored in the comment list 611 and the personal importance level stored in the user list 612. In this example, as the importance level of the comment, the importance level is calculated in consideration of not only the overall collective importance level such as receiving many evaluations of “like” but also the importance level customized for an individual such as being a fan of a specific artist.

A comment display control unit 614 displays (arranges) the comments in the virtual space on the basis of the position information of the user (avatar), the exhibits, or others. In addition, when displaying the comments, the comment display control unit 614 controls how to show (noticeability) the comments to be displayed on the basis of the importance levels calculated by the comment importance calculating unit 613.

For example, as a manner of showing the comments, as a comment has a higher importance level, the size of the character is increased, or the comment is displayed in a color different from that of other comments. Alternatively, the comments may be classified into popular comments, unpopular comments, or others, and the manner of showing the comments may be modified for each classification. For example, the size of characters can be increased for popular comments, whereas the size of characters can be decreased for unpopular comments.

Furthermore, a button capable of inputting a user's evaluation (reaction) such as “like” or “downvote” is prepared for the comment, and when a user evaluates the comment as “like”, the comment is displayed such that the character size of the comment becomes larger. Meanwhile, when a user does not evaluate the comment as “like”, the comment is displayed such that the character size of the comment becomes smaller.

In a case where a display time is set for a comment, when a user evaluates the comment as “like”, the display time of the comment may be extended and displayed longer than other comments. When a comment is evaluated as “downvote” by a user or when a predetermined period of time has elapsed in a case where a display time is set, the comment may be hidden.

Instead of displaying the entire character string of the comment, only one word or the title may be displayed from the character string of the comment. Alternatively, a comment touched by many users, in such a manner that an avatar moving in the virtual space touches the comment, may be larger in size or added with a specific effect (for example, a flashy effect).

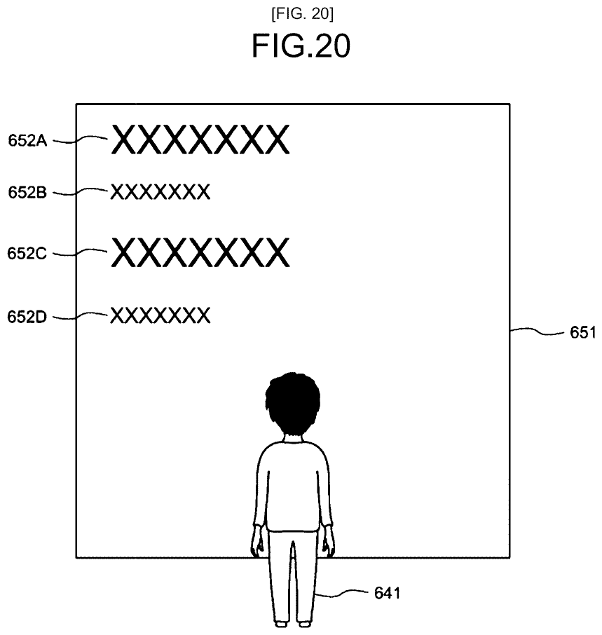

Furthermore, as illustrated in FIGS. 20 to 22, the display method can be modified depending on a space in which the comments are displayed.

FIG. 20 is a diagram illustrating an example of 2D display of comments. In FIG. 20, comments 652A to 652D are displayed in a 2D display space 651 for an avatar 641. The comments 652A to 652D have different character sizes. For example, a comment evaluated as “like” has a larger character size, and a comment not evaluated as “like” has a smaller character size.

In FIG. 20, the presence or absence of a display time and the display time in a case where there is a display time can be set for each of the comments 652A to 652D. Furthermore, among the comments 652A to 652D, a comment evaluated as “like” can have its display time extended.

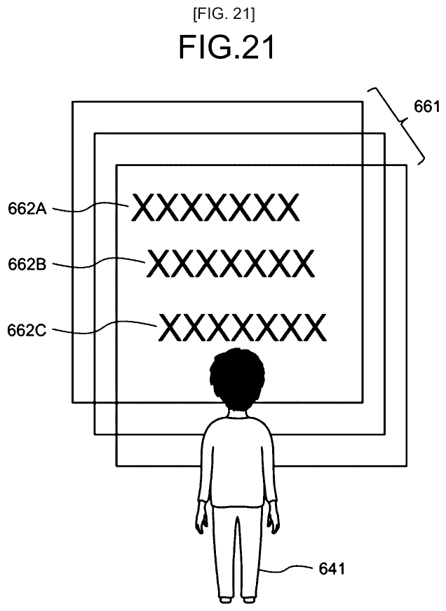

FIG. 21 is a diagram illustrating a first example of 3D display of comments. In FIG. 21, comments 662A to 662C are displayed in a 3D display space 661 having a depth with respect to the avatar 641. The comments 662A to 662C can be arranged on the front side of the 3D display space 661 with respect to the avatar 641. For example, displaying and hiding of the comments 662A to 662C may be made switchable, and the comments 662A to 662C that have been hidden may be displayed when the avatar 641 approaches the 3D display space 661 to a predetermined distance.

In FIG. 21, the comments 662A to 662C can be displayed depending on the importance level. For example, in a case where the comment 662B has the highest importance level among the comments 662A to 662C, only the comment 662B can be displayed even when the avatar 641 is located away from the 3D display space 661.

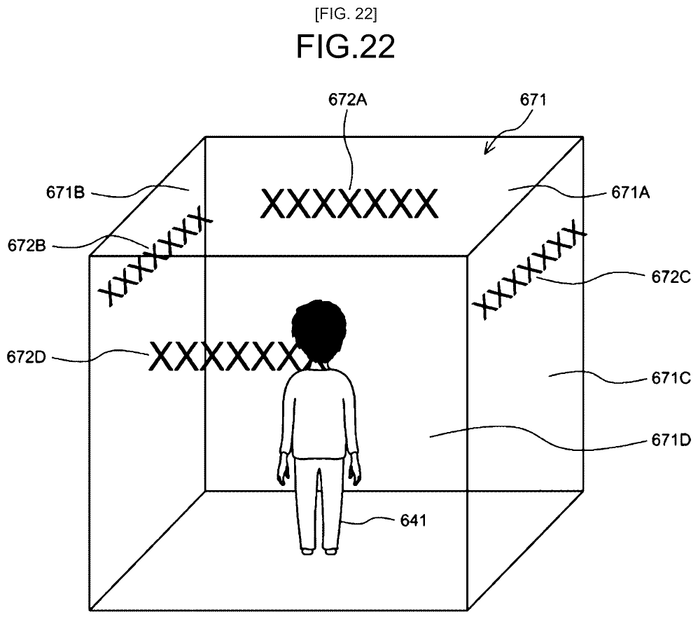

FIG. 22 is a diagram illustrating a second example of 3D display of comments. In FIG. 22, comments 672A to 672D are displayed in a 3D display space 671 surrounding the avatar 641.

In FIG. 22, among the comments 672A to 672D, the comment 672A having the highest importance level is displayed on a front face 671A, and the comment 672D having the lowest importance level is displayed on a back face 671D. Furthermore, since the comment 672B and the comment 672C have an intermediate importance level, they are displayed on a left face 671B and a right face 671C, respectively. As a result, the user can easily check the comment 672A having the highest importance level displayed on the front face 671A from a specific viewpoint corresponding to the avatar 641.

Note that the moving speed of a comment that can move in the virtual space may change depending on the importance level. For example, the higher the importance level of a comment is, the visibility by the user can be enhanced by slowing down the moving speed and displaying slowly. Furthermore, the color or others of characters may be modified depending on a destination of the comment. An inappropriate comment may be hidden or deleted by notifying an administrator or the like.

Furthermore, in the above-described example, the importance level of the comments has been described; however, for example, it is also possible to perform control with respect to the priority of the comments in a similar manner to the importance level. Furthermore, the importance level and the priority of the comments are examples of the attribute information of the comments, and also regarding the attribute information such as reactions (for example, evaluation of “like”) by users to the comments and information regarding users who have input the comments, the comments can be arranged (displayed) depending on the content of the attribute information.

As described above, the manner of showing the comments corresponds to the comment display (S3) among the comment states of FIG. 5, and the comment display for each user is controlled depending on the importance level of the comments, users' reactions to the comments, and others.

Note that, in the configuration example illustrated in FIG. 19, the comment importance calculating unit 613 and the comment display control unit 614 are provided as functions of the processing unit 251 in FIG. 4. Furthermore, the comment list 611 and the user list 612 are recorded in the storage unit 254 of FIG. 4.

<Conversion of User's Voice into 3D Text>

The voice uttered by a user such as by voice chat may be converted into 3D text, which may be caused to appear in the virtual space. For example, by enabling the user's voice converted into the 3D text to be registered as a comment on an exhibit in the virtual space, the user can save the trouble of manually inputting the comment. Furthermore, messages and cheers by the voice of users as fans of an artist may be individually recognized and displayed on a large screen in the virtual space or may be displayed by being attached to a wall surface or a 3D object.

FIG. 23 is a diagram illustrating a configuration example for converting user's voice into 3D text. In FIG. 23, user's voice such as a message or cheers is input to a voice recognition unit 711 and a tone analysis unit 713.

The voice recognition unit 711 performs voice recognition processing on the user's voice input thereto, converts the user's voice into text, and supplies the text to an important word extraction and sentence interpretation unit 712 as a voice recognition result. As the voice recognition processing, a known technology can be used.

On the basis of the voice recognition result from the voice recognition unit 711, the important word extraction and sentence interpretation unit 712 performs processing such as extraction of important words included in the user's voice text and interpretation of a sentence and supplies character data obtained as a result to a 3D character generation unit 714.

The tone analysis unit 713 performs tone analysis processing on the user's voice input thereto and supplies format information obtained as a result thereof to the 3D character generation unit 714. Incidentally, the format information indicates a format corresponding to the user's voice analyzed in the tone analysis processing.

For example, variations of the format include the texture, the material, the action, and others. The texture includes colors, patterns, and others. The material includes the elasticity, the hardness, the weight, the size, the reflection coefficient of light, friction, ice, flames, electricity, water, and others. The action is an action when an avatar touches a character in the virtual space and includes shining, burning, freezing, being blown, and others.

The tone analysis is processed by the tone analysis unit 713, or setting information manually set by the user may be used. Note that a sound effect may be added to the 3D text generated by the 3D character generation unit 714 in the subsequent stage.

The 3D character generation unit 714 generates 3D text in which character data from the important word extraction and sentence interpretation unit 712 is matched to the format indicated by the format information from the tone analysis unit 713 and stores the 3D text in a 3D text DB 715. The 3D text stored in the 3D text DB 715 in this manner can be disposed in the virtual space. The 3D text may be subjected to various adjustments of the position, the color, and the like before being disposed in the virtual space.

Note that, in the configuration illustrated in FIG. 23, the important word extraction and sentence interpretation unit 712 is not necessarily included, and the 3D text may be displayed for all the words in the user's voice text without extracting important words included therein. Alternatively, 3D text corresponding to an important word may be disposed (displayed), and 3D text corresponding to all the words may be displayed when the 3D text is selected (such as a tap operation) by the user.

In this manner, by converting the user's voice into 3D text and attaching the 3D text on a 3D object or the like, the user's voice can be expressed as a 3D object. It is also made possible to express the personality of an individual user (for example, a tone, the volume of voice, intonation, and others) by the material, the color, the size, the action, or others of the 3D object.

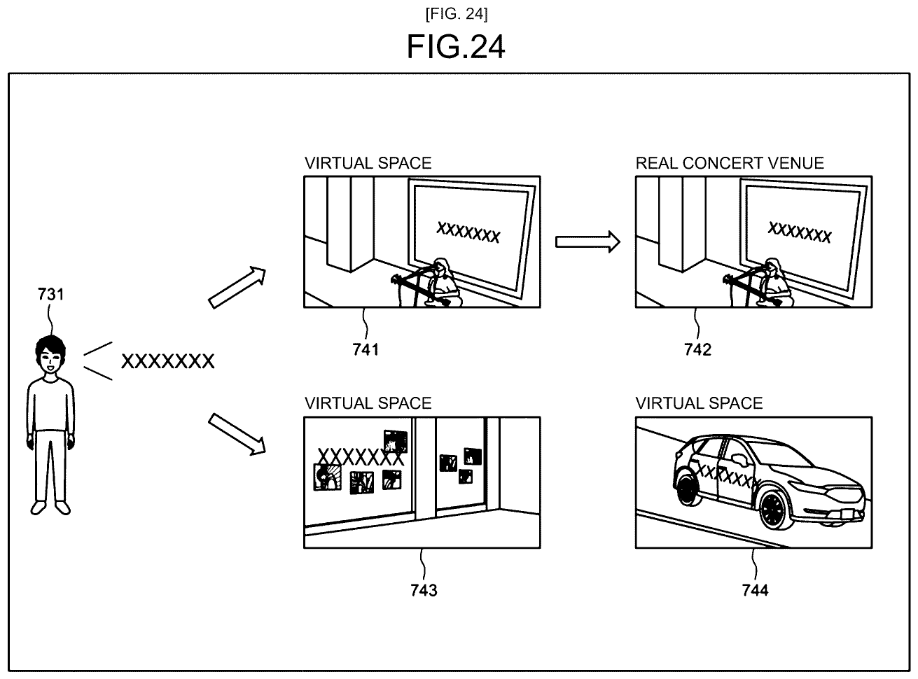

The 3D text generated from the user's voice may be also shared in the real space not only being disposed in the virtual space. FIG. 24 is a diagram illustrating examples of sharing of 3D text between a virtual space and a real space. In FIG. 24, when a user 731 in the real space utters a voice of “XXXXXXX”, the voice is converted into 3D text, which can be displayed in the virtual space.

For example, a message of “XXXXXXX” converted into 3D text is displayed on a large screen of a concert implemented in a virtual space 741. Meanwhile, in a real concert held in a real space 742, a similar message can be also displayed on a large screen installed in a real concert venue. For example, the concert in the virtual space 741 and the concert in the real space 742 are performed by the same artist, and the message (cheers) of “XXXXXXX” uttered by the user 731 who is a fan of the artist is converted into text and shared.

Furthermore, “XXXXXXX” obtained by converting user's voice into 3D text may be pasted and displayed on a wall surface in a virtual space 743 with the user 731 using voice chat or the like. Similarly, 3D text of “XXXXXXX” may be pasted to a 3D object such as a car present in a virtual space 744 and displayed as the 3D object. Note that it is also possible to treat a 3D object in a special manner by converting voice uttered by a celebrity into 3D text and attaching the 3D text to the 3D object.

In this manner, by converting the user's voice into text and displaying the text, it is possible to share, between a virtual space and a real space, messages and cheers by the voices of fans of an artist, for example. Moreover, with regards to text obtained by conversion from user's voice and displayed, it is possible to display the text on the large screen or a 3D object or to record the text while explicitly indicating who has uttered the message and where the message is directed.

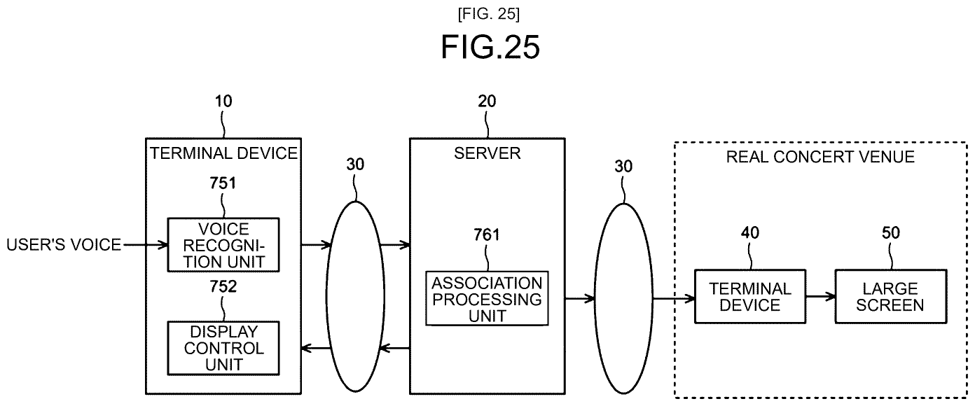

FIG. 25 is a diagram illustrating a configuration example for sharing 3D text between a virtual space and a real space. In FIG. 25, a terminal device 10 used by a user is connected to the server 20 via the network 30. In the terminal device 10, an application is activated.

The server 20 is connected with the terminal device 10 and is also connected with a terminal device 40 installed in a real concert venue via networks 30. In the real concert venue, the terminal device 40 is connected with a large screen 50 as a display device and can cause to display information such as video and text.

In the terminal device 10, voice uttered by a user such as voice chat is collected by a microphone and input to a voice recognition unit 751. The voice recognition unit 751 performs voice recognition processing on the user's voice, and the user's voice is converted into 3D text. The terminal device 10 transmits text information obtained by the 3D text conversion together with a personal ID for identifying the user who has uttered the voice to the server 20 via the network 30.

In the server 20, an association processing unit 761 associates the personal. ID and the text information transmitted from the terminal device 10 and transmits the association information obtained as a result thereof to the terminal device 10 and the terminal device 40 via the networks 30.

In the terminal device 10, a display control unit 752 performs control such that the 3D text corresponding to the user's voice is displayed on a large screen of a concert in a virtual space on the basis of the association information from the server 20. In the real concert venue, the terminal device 40 performs control such that text corresponding to the user's voice is displayed on the large screen 50 on the basis of the association information from the server 20.

As described above, the conversion of the user's voice into 3D text corresponds to the comment preparation (S1) among the comment states of FIG. 5, in which the user's voice can be converted into 3D text and arranged in the virtual space. Furthermore, the 3D text corresponding to the user's voice can be not only disposed in the virtual space but also shared in the real space. In the above example, the case where the message displayed on the large screen is shared in the concerts in the virtual space and the real space has been described; however, similarly, a comment on an exhibit of a virtual exhibition (virtual space) may be shared and displayed on a display device such as a display device installed in an exhibition in a real space.

Note that, in the configuration example illustrated in FIG. 23, the voice recognition unit 711, the important word extraction and sentence interpretation unit 712, the tone analysis unit 713, and the 3D character generation unit 714 are provided as functions of the processing unit 251 in FIG. 4. The 3D text DB 715 is recorded in the storage unit 254 of FIG. 4.

Furthermore, in the configuration example illustrated in FIG. 25, the voice recognition unit 751 and the display control unit 752 are provided as functions of the processing unit 251 of a terminal device 10. The association processing unit 761 is provided as a function of the processing unit 251 of the server 20.

<Communication with Artist>

The comments on the exhibits are not limited to comments by general users and may include an artist's comment who is on the hosting side of the exhibition. In such a case, by distinguishing between the artist's comment and comments of the general users and displaying such that the artist's comment stands out, it is made possible to facilitate the users to communicate with the artist.

For example, when a user operates the terminal device 10 on which the application has been activated and views the exhibit in the virtual space, a terminal screen 811 as illustrated in FIG. 26 is displayed on the display unit 131. On the terminal screen 811, exhibits 812 such as paintings and photographs installed in the virtual space, comments 813A to 813C by general users on the exhibits 812, and an avatar 814 of the user are displayed.

Furthermore, a comment 821 of “Take a look at here” is displayed on the terminal screen 811. The comment 821 is an artist's comment for the virtual exhibition (exhibits 812) and is displayed in such a manner as to be distinguishable from the comments 813A to 813C of the general user such as “Nice!”. The comment 821 can be made distinguishable from the comments 813A to 813C of the general user by, for example, being displayed with light, being displayed on the front side with respect to other comments for the user in the case of a 3D display space having a depth, or adding a mark.

Alternatively, among the comments on the exhibits, a mode in which only the comment 821 of the artist can be viewed may be prepared so that the user can select the mode. When the user selects the mode, only the comment 821 of the artist is displayed without displaying the comments 813A to 813C of the general users, which can ensure that the user reads the comment 821 of the artist.

Furthermore, a sticker 822 in which a drawing related to the artist is shown is displayed on the terminal screen 811. The sticker 822 is for distinguishing a comment for the users (artist sticker). The sticker 822 includes a 3D avatar or the like that performs a predetermined operation. Note that, when the artist makes a reaction to a comment, a notification may be given to the user who has written the comment.

Incidentally, as a management method of comments of general users and artists, for example, information for distinguishing a registrant (such as a general user or an artist) is associated at the time of registering each comment in a database storing the comments. As a result, at the time of displaying the comments, it is possible to distinguish which one of the general user and the artist has registered a comment and to display the comments of the general users and the artist's comment in different manners.

As described above, communication with the artist corresponds to the comment display (S3) among the comment states of FIG. 5, and the artist's comment and the comments of the general users can be displayed in a distinguishable manner. Furthermore, artist's comments are classified into two cases of a comment for an exhibit and a comment for users, whereby a user interface (UI) with higher noticeability is provided.

### <Overview of Processing>

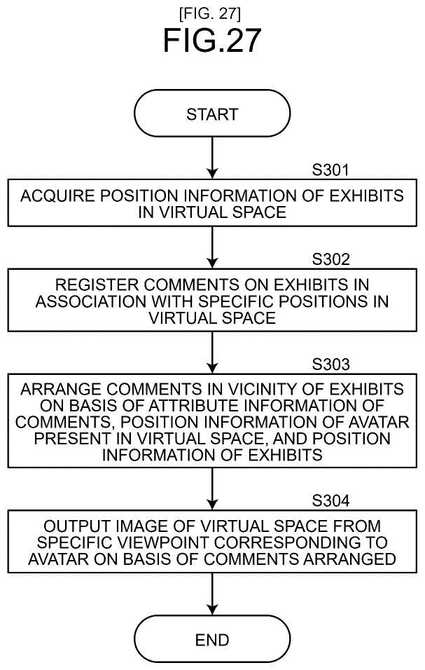

FIG. 27 is a flowchart explaining an overview of processing to which the present disclosure is applied. The processing illustrated in FIG. 27 is implemented by the processing unit 251 of the server 20 or a terminal device 10 or is implemented by the processing unit 251 of the server 20 and the processing unit 251 of a terminal device 10 operating in cooperation.

In step S301, the position information acquisition unit 261 acquires the position information of the exhibits in the virtual space. In step S302, the comment registration unit 262 registers the comments on the exhibits in association with specific positions in the virtual space.

In step S303, the comment arrangement unit 263 arranges the comments in the vicinity of the exhibits on the basis of the attribute information of the comments, the position information of the avatar present in the virtual space, and the position information of the exhibits. In a case where there is a plurality of comments on the exhibits, the comment arrangement unit 263 arranges the plurality of comments in the vicinity of the exhibits on the basis of attribute information of each of the plurality of comments, the position information of the avatar, and the position information of the exhibits. The attribute information of the comments includes reactions of users to the comments, information regarding users who has input the comments, importance levels or priority levels of the comments, and the like.

In step S304, the image output unit 264 outputs an image of the virtual space from a specific viewpoint corresponding to the avatar on the basis of the comments arranged. The output image of the virtual space is displayed on the display unit 131 of the terminal device 10.

As described above, in the processing to which the present disclosure is applied, since the arrangement of the comments with respect to the exhibits is controlled on the basis of the attribute information of the comments or the like in the virtual space of the virtual exhibition, the comments on the exhibits in the virtual space can be more appropriately arranged. Since a virtual space such as the virtual exhibition is an online space in which users interact with each other via avatars, the virtual space can also be referred to as a metaverse space.

Note that the processing of map display of the comment amounts, the processing of SNS sharing, the processing of comment display for each user, the processing of comment rearrangement, the processing of how to show the comments, the processing of converting the user's voice into 3D text, and the processing of communication with the artist described above are also, similarly, implemented by the processing unit 251 of the server 20 or a terminal device 10 or is implemented by the processing unit 251 of the server 20 and the processing unit 251 of a terminal device 10 operating in cooperation.

In the present specification, the term “automatically” means that a device such as the terminal devices 10 or the server 20 performs processing without a direct operation by the user, and the term “manually” means that processing is performed via a direct operation by the user.

The processing of each step of the above-described flowcharts can be executed by hardware or software. In a case where the series of processing is executed by software, a program included in the software is installed in a computer of each device.

The program executed by the computer can be provided, for example, by being recorded in a removable recording medium as a package medium or the like. Furthermore, the program can be provided via a wired or wireless transmission medium such as a LAN, the Internet, or digital satellite broadcasting.

In the computer, the program can be installed in a storage unit via an input and output I/F by mounting the removable recording medium in a drive. Alternatively, the program can be received by a communication unit via a wired or wireless transmission medium and installed in the storage unit. In addition, the program can be installed in advance in the ROM or the storage unit.

In the present specification, the processing performed by the computer in accordance with the program is not necessarily performed in time series in the order described as the flowcharts. That is, processing performed by the computer in accordance with the program also includes processing executed in parallel or individually (for example, parallel processing or processing by an object).

Moreover, the program may be processed by one computer (processor) or may be processed in a distributed manner by a plurality of computers. Furthermore, the program may be transferred to and executed by a remote computer.

Note that the embodiments of the present disclosure are not limited to the above-described embodiments, and various modifications can be made without departing from the gist of the present disclosure. Furthermore, the effects described herein are merely examples and are not limited, and other effects may be achieved.

Furthermore, the present disclosure can have the following configurations.
(1) An information processing device comprising:
   a position information acquisition unit that acquires position information indicating a position of an exhibit in a virtual space;
   a comment registration unit that registers a comment on the exhibit in association with a specific position in the virtual space;
   a comment arrangement unit that disposes the comment in a vicinity of the exhibit on a basis of attribute information of the comment, position information indicating a position of an avatar present in the virtual space, and position information of the exhibit; and
   an image output unit that outputs an image of the virtual space from a specific viewpoint corresponding to the avatar on a basis of the comment that has been disposed.
(2) The information processing device according to (1),
   wherein the comment arrangement unit arranges a plurality of comments on the exhibit in the vicinity of the exhibit.
(3) The information processing device according to (2),
   wherein the comment arrangement unit arranges the plurality of comments in the vicinity of the exhibit on a basis of attribute information of each of the plurality of comments, the position information of the avatar, and the position information of the exhibit.
(4) The information processing device according to (3),
   wherein the comment arrangement unit arranges the plurality of comments in the vicinity of the exhibit depending on an importance level of each of the comments.
(5) The information processing device according to any one of (2) to (4),
   wherein the comment arrangement unit moves a comment, which is disposed at an overlapping position, among the plurality of comments to a non-overlapping position.
(6) The information processing device according to any one of (1) to (4),
   wherein the attribute information of the comment includes a reaction of a user to the comment.
(7) The information processing device according to any one of (1) to (4),
   wherein the attribute information of the comment includes information regarding a user who has input the comment.
(8) The information processing device according to any one of (1) to (4),
   wherein the image output unit outputs a bird's-eye view image of the virtual space mapped with the exhibit in the virtual space.
(9) The information processing device according to (8),
   wherein the image output unit superimposes information regarding a comment amount for the exhibit on the bird's-eye view image.
(10) The information processing device according to any one of (1) to (4),
   wherein the comment arrangement unit prevents the comment from being disposed in an area where the comment cannot be disposed.
(11) The information processing device according to (10),
   wherein the area where the comment cannot be disposed is either set in advance or set on a basis of information regarding the specific viewpoint corresponding to the avatar.
(12) The information processing device according to any one of (1) to (4),
   wherein at least one of an orientation or a position of the comment disposed in the vicinity of the exhibit is adjusted on a basis of at least one of the attribute information of the comment, the position information of the avatar, or the position information of the exhibit.
(13) The information processing device according to any one of (1) to (4),
   wherein a color of the comment is adjusted depending on a background of the comment disposed in the vicinity of the exhibit.
(14) The information processing device according to any one of (1) to (4),
   wherein at least one of a character size or interline spacing of the comment disposed in the vicinity of the exhibit is adjusted depending on an angle of view of an image of the virtual space to be output.
(15) The information processing device according to any one of (1) to (4),
   wherein the comment includes an artist's comment and a comment of a user, and
   the artist's comment and the comment of the user are adjusted in a distinguishable manner.
(16) The information processing device according to (6),
   wherein the image output unit outputs an image of the virtual space on a basis of the comment including a favorable evaluation as a reaction of the user, and
   the image of the virtual space that is output is posted on a social networking service (SNS).
(17) The information processing device according to any one of (1) to (4),
   wherein the comment is obtained by converting user's voice into text by voice recognition.
(18) The information processing device according to (17),
   wherein the comment is displayed on a display device in a real space.
(19) An information processing method, by an information processing device, comprising:
   acquiring position information indicating a position of an exhibit in a virtual space;
   registering a comment on the exhibit in association with a specific position in the virtual space;
   disposing the comment in a vicinity of the exhibit on a basis of attribute information of the comment, position information indicating a position of an avatar present in the virtual space, and position information of the exhibit; and
   outputting an image of the virtual space from a specific viewpoint corresponding to the avatar on a basis of the comment that has been disposed.
(20) A recording medium storing a program for causing a computer to function as:
   a position information acquisition unit that acquires position information indicating a position of an exhibit in a virtual space;
   a comment registration unit that registers a comment on the exhibit in association with a specific position in the virtual space;
   a comment arrangement unit that disposes the comment in a vicinity of the exhibit on a basis of attribute information of the comment, position information indicating a position of an avatar present in the virtual space, and position information of the exhibit; and
   an image output unit that outputs an image of the virtual space from a specific viewpoint corresponding to the avatar on a basis of the comment that has been disposed.

### REFERENCE SIGNS LIST

1 SYSTEM
10, 10-1 to 10-N TERMINAL DEVICE
20 SERVER
30 NETWORK
40 TERMINAL DEVICE
50 LARGE SCREEN
101 CPU
201 CPU
250 CONTROL UNIT
251 PROCESSING UNIT
252 INPUT AND OUTPUT UNIT
253 COMMUNICATION UNIT
254 STORAGE UNIT
261 POSITION INFORMATION ACQUISITION UNIT
262 COMMENT REGISTRATION UNIT
263 COMMENT ARRANGEMENT UNIT
264 IMAGE OUTPUT UNIT
611 COMMENT LIST
612 USER LIST
613 COMMENT IMPORTANCE CALCULATING UNIT
614 COMMENT DISPLAY CONTROL UNIT
711 VOICE RECOGNITION UNIT
712 IMPORTANT WORD EXTRACTION AND SENTENCE INTERPRETATION UNIT
713 TONE ANALYSIS UNIT
714 3D CHARACTER GENERATION UNIT
715 3D TEXT DB
751 VOICE RECOGNITION UNIT
752 DISPLAY CONTROL UNIT
761 ASSOCIATION PROCESSING UNIT

1. An information processing device comprising:
a position information acquisition unit that acquires position information indicating a position of an exhibit in a virtual space;
a comment registration unit that registers a comment on the exhibit in association with a specific position in the virtual space;
a comment arrangement unit that disposes the comment in a vicinity of the exhibit on a basis of attribute information of the comment, position information indicating a position of an avatar present in the virtual space, and position information of the exhibit; and
an image output unit that outputs an image of the virtual space from a specific viewpoint corresponding to the avatar on a basis of the comment that has been disposed.

2. The information processing device according to claim 1,
wherein the comment arrangement unit arranges a plurality of comments on the exhibit in the vicinity of the exhibit.

3. The information processing device according to claim 2,
wherein the comment arrangement unit arranges the plurality of comments in the vicinity of the exhibit on a basis of attribute information of each of the plurality of comments, the position information of the avatar, and the position information of the exhibit.

4. The information processing device according to claim 3,
wherein the comment arrangement unit arranges the plurality of comments in the vicinity of the exhibit depending on an importance level of each of the comments.

5. The information processing device according to claim 2,
wherein the comment arrangement unit moves a comment, which is disposed at an overlapping position, among the plurality of comments to a non-overlapping position.

6. The information processing device according to claim 1,
wherein the attribute information of the comment includes a reaction of a user to the comment.

7. The information processing device according to claim 1,
wherein the attribute information of the comment includes information regarding a user who has input the comment.

8. The information processing device according to claim 1,
wherein the image output unit outputs a bird's-eye view image of the virtual space mapped with the exhibit in the virtual space.

9. The information processing device according to claim 8,
wherein the image output unit superimposes information regarding a comment amount for the exhibit on the bird's-eye view image.

10. The information processing device according to claim 1,
wherein the comment arrangement unit prevents the comment from being disposed in an area where the comment cannot be disposed.

11. The information processing device according to claim 10,
wherein the area where the comment cannot be disposed is either set in advance or set on a basis of information regarding the specific viewpoint corresponding to the avatar.

12. The information processing device according to claim 1,
wherein at least one of an orientation or a position of the comment disposed in the vicinity of the exhibit is adjusted on a basis of at least one of the attribute information of the comment, the position information of the avatar, or the position information of the exhibit.

13. The information processing device according to claim 1,
wherein a color of the comment is adjusted depending on a background of the comment disposed in the vicinity of the exhibit.

14. The information processing device according to claim 1,
wherein at least one of a character size or interline spacing of the comment disposed in the vicinity of the exhibit is adjusted depending on an angle of view of an image of the virtual space to be output.

15. The information processing device according to claim 1,
wherein the comment includes an artist's comment and a comment of a user, and
the artist's comment and the comment of the user are adjusted in a distinguishable manner.

16. The information processing device according to claim 6,
wherein the image output unit outputs an image of the virtual space on a basis of the comment including a favorable evaluation as a reaction of the user, and
the image of the virtual space that is output is posted on a social networking service (SNS).

17. The information processing device according to claim 1,
wherein the comment is obtained by converting user's voice into text by voice recognition.

18. The information processing device according to claim 17,
wherein the comment is displayed on a display device in a real space.

19. An information processing method, by an information processing device, comprising:
acquiring position information indicating a position of an exhibit in a virtual space;
registering a comment on the exhibit in association with a specific position in the virtual space;
disposing the comment in a vicinity of the exhibit on a basis of attribute information of the comment, position information indicating a position of an avatar present in the virtual space, and position information of the exhibit; and
outputting an image of the virtual space from a specific viewpoint corresponding to the avatar on a basis of the comment that has been disposed.

20. A recording medium storing a program for causing a computer to function as:
a position information acquisition unit that acquires position information indicating a position of an exhibit in a virtual space;
a comment registration unit that registers a comment on the exhibit in association with a specific position in the virtual space;
a comment arrangement unit that disposes the comment in a vicinity of the exhibit on a basis of attribute information of the comment, position information indicating a position of an avatar present in the virtual space, and position information of the exhibit; and
an image output unit that outputs an image of the virtual space from a specific viewpoint corresponding to the avatar on a basis of the comment that has been disposed.
